(19) United States
(12) Patent Application Publication
(10) Pub. No.: US 2010/0172605 A1
(43) Pub. Date: Jul. 8, 2010

(54) ROLLING BEARING DEVICE COMPRISING AN INTEGRATED SENSOR SYSTEM

(75) Inventors: Michael Pausch, Oberwerrn (DE); Manfred Fuchs, Gaedheim (DE); Frank Benkert, Waigolshausen (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/527,072

(22) PCT Filed: Jan. 22, 2008
(86) PCT No.: PCT/DE2008/000106

§ 371 Date: Jan. 11, 2010

(30) Foreign Application Priority Data
Feb. 14, 2007 (DE) 10 2007 007 213.0
Sep. 6, 2007 (DE) 10 2007 042 478.9

(51) Int. Cl. F16C 32/04; F16C 32/00; F16C 43/04; F16C 33/38

(52) U.S. Cl. 384/446; 384/448; 384/561; 384/523

(57) ABSTRACT

A rolling bearing device, which has a first bearing ring, a second bearing ring, rolling bodies in a pathway region that is defined between the two bearing rings, a cage device for separating the rolling bodies, and a sensor system for generating a sensor signal relating to the relative rotation of the inner ring in relation to the outer ring. The sensor system is embodied in such a way that the sensor signal is collected on the basis of an interaction effect between a signal tapping element and a structure rotating with the cage device. Thus, it is advantageously possible to create rolling bearing devices which have an integrated sensor system and outer dimensions which correspond essentially to the standard outer dimensions for such rolling bearing devices. Moreover, standard rolling bearings can be modified to form inventive rolling bearings by replacement of the bearing sealing ring.

### FIELD OF THE INVENTION

The invention relates to a rolling bearing device having a first bearing ring, a second bearing ring, rolling bodies which are held in a race chamber delimited between said two bearing rings, and a sensor system for generating a sensor signal which relates to the relative rotation of the inner ring with respect to the outer ring.

### BACKGROUND OF THE INVENTION

DE 698 260 55 T2 discloses a rolling bearing having a measurement value sensor. In said conventional rolling bearing, a sensor ring is placed onto an end surface region of an outer ring of the rolling bearing, which sensor ring itself engages around a transducer ring. The transducer ring is seated on an end surface of the inner ring. During a rotation of the inner ring with respect to the outer ring, impulses are generated by means of the transducer ring, which impulses can be detected by means of the sensor ring which is fixed to the outer ring.

DE 601 092 32 T2 likewise discloses a rolling bearing which is fitted with a sensor device by means of which the rotational movement of the inner ring of the bearing with respect to the outer ring of the bearing can be measured. Said sensor device comprises a transducer ring, which is fixed to the inner ring of the bearing, and a sensor ring, which is placed onto the outer ring of the bearing. The sensor ring is designed such that a magnetic field which is generated by the transducer ring can be detected by said sensor ring as said magnetic field passes by the corresponding sensor section.

### PROBLEM ADDRESSED BY THE INVENTION

The problem addressed by the invention is that of creating a rolling bearing device having an integrated sensor system, which rolling bearing device can be produced in a cost-effective manner from a manufacturing aspect, and the installation of which rolling bearing device in a corresponding mechanism may be carried out with a high degree of design freedom.

### SOLUTION ACCORDING TO THE INVENTION

Said problem is solved according to the invention by means of a rolling bearing device having:
a first bearing ring,
a second bearing ring,
rolling bodies which are held in a race chamber delimited between said two bearing rings,
a cage device for separating the rolling bodies, and
a sensor system for generating a sensor signal which relates to the relative rotation of the inner ring with respect to the outer ring, with said rolling bearing device being characterized in that the sensor system is designed such that said sensor signal is generated on the basis of an interaction effect between a signal tapping element and a structure which rotates together with the cage device.

Said problem is likewise solved according to the invention by means of a rollin bearing device having:
a first bearing ring,
a second bearing ring,
at least one rolling body which is held in a race chamber delimited between said two bearing rings, and
a sensor system for generating a sensor signal which relates to the relative rotation of the first bearing ring with respect to the second bearing ring,
with the sensor system comprising a sensor element and a signal transducer,
with said rolling bearing device being characterized in that the sensor system is designed such that said sensor element comprises at least one reed contact, and in that the at least one reed contact detects a magnetic signal of the signal transducer as a sensor signal.

In this way, it is advantageously made possible to create rolling bearing devices which have an integrated sensor system and whose external dimensions correspond substantially with the standard external dimensions for such rolling bearing devices.

It is particularly advantageously made possible for standard rolling bearings to be modified into a rolling bearing according to the invention by simply exchanging the bearing sealing ring.

According to one particularly preferred embodiment of the invention, the signal tapping element is incorporated into a bearing cover ring which is designed as a relatively flat annular disk. Said bearing cover ring is preferably fixed to that bearing ring of the rolling bearing device which, in the installed state of the rolling bearing device, forms the stationary bearing ring. Here, the bearing cover ring according to the invention may, in particular, be clipped into an inner circumferential groove of the outer ring of the rolling bearing device in the manner of a standard bearing sealing disk. For applications in which the inner ring forms the stationary component, it is also possible for the bearing cover ring to be designed so as to be clipped into a retaining groove which is formed on the bearing inner ring.

The bearing cover ring according to the invention, which functions as a bearing seal, is preferably formed as a multi-material component, which comprises a relatively dimensionally rigid annular disk core and an elastomer casing which covers preferably the entire surface of said annular disk core. The sealing lip devices which are provided for realizing the sealing action preferably form an integral constituent part of the bearing cover ring.

The sensor element according to the invention is preferably designed so as not to project in the axial direction beyond the end surface region of the bearing.

The sensor element according to the invention may in particular be designed such that the structure which rotates with the cage, in particular the cage itself or a transducer element which is embedded in the cage, is detected on the basis of electromagnetic interaction effects and/or electric field interaction effects.

It may, for example, be provided that the body of the bearing ring is magnetic in sections.

In particular, it is possible for said transducer element to be formed as a small permanent magnet which is fixed to the cage device. It is also possible for the transducer element to be produced from a merely magnetizable material or some other ferromagnetic material.

It is preferably provided, with regard to the transducer element, that the transducer element is fastened to an end side of the cage or of the cage device. Here, the transducer element may be formed by at least one permanent magnet; alternatively, the transducer element may be formed by an encoder disk. Here, the encoder disk is designed as a circular ring which is attached to the end surface of the body of the bearing cage or of the cage device and which faces toward the sensor element. In the circular ring of the encoder disk, at least two plane regions are provided in which magnetization is provided, with the magnetization of adjacent regions being different.

The encoder disk, which is designed as a transducer element, is preferably arranged on a bearing cage composed of plastic, with the plastic of the body of the bearing cage being non-magnetic and with substantially only the magnetic field of the transducer element, therefore in particular of the encoder disk, occurring in the region of the sensor element. The use of plastic offers numerous options for fastening the transducer element, for example adhesive bonding, plugging, screwing or clipping the transducer element to the body of the bearing cage or cage device.

The bearing cage is particularly preferably designed as a plastic snap-action cage in which the rolling bodies are introduced laterally and in which a continuous end surface is provided to which the transducer element, in particular, the encoder disk, can be fastened. Here, the transducer element which is fastened to the end surface of the bearing cage is spaced apart from a grease chamber, which is an advantage which is not always obtained with a sheet-metal cage.

It is particularly preferably provided, with regard to the encoder disk, that said encoder disk is produced from a circular ring from a ferromagnetic material or at least magnetized material, and in that cutouts are formed into the body of the circular ring. The cutouts then form, together with the remaining sections of the body of the circular ring, the encircling sequence of sections with alternating, that is to say in particular existent and non-existent, magnetization. Such an encoder disk can be easily produced, for example, from magnetic steel.

An alternative embodiment of the encoder disk to this preferably provides to design the body of the encoder disk as a continuous, uninterrupted circular ring, and that magnetized and non-magnetized sections, or sections of different magnetization, are provided in the circumferential direction of the circular ring.

With regard to the material of the encoder disk, it is preferably provided that the encoder disk is produced from metal, in particular from a ferromagnetic or at least magnetizable metal, or from a ferromagnetic plastic.

The sensor element itself may be designed as a reed contact, as an induction coil device or in particular also as a Hall effect sensor structure. It is preferable for the sensor element to be designed as a reed contact because reed contacts are of very small design and have dimensions of only a few mm. Furthermore, reed contacts provide an on-off signal in the manner of switches depending on whether or not the reed contact is closed, in contrast to Hall effect sensors or induction coils which measure the respective measurement variable continuously, and in which a digitalization must take place downstream. A further advantage of reed contacts has proven to be that they do not require a supply voltage, but rather simply close an electrical circuit if the reed contact is activated. In contrast, Hall effect sensors or induction coil devices require a constant supply voltage.

It is possible for an ASIC circuit to be incorporated into the rolling bearing, in particular in the region of the sensor element, which ASIC circuit itself carries out signal pre-processing of the measured detection events already directly in the region of the measuring point. Said ASIC circuit may, in particular, comprise an operational amplifier and a protective circuit in order to prevent damage to the typically sensitive sensor element itself as a result of over-voltages. It is also possible for the ASIC circuit to be configured in such a way that an output signal, which is provided in a certain signal standard, in particular in bus format, is generated already in the region of the rolling bearing device.

According to one particular aspect of the present invention, the sensor system comprises a plurality of sensor elements. Said sensor elements may be arranged in such a way that the circumferential angular spacing of the stationary sensor elements is coordinated with the circumferential angular spacing of the transducer structures in such a way that the relative movement of the two bearing rings can be measured with an increased resolution. It is thus possible, in particular for the sensor elements and the transducer structures, to be arranged such that the relative rotation between the inner ring and the outer ring can be measured on the basis of a nonius principle with a resolution of, for example, 15 degrees.

According to a further aspect of the present invention, it is also possible for the rolling bearing device to be designed such that the sensor system can be inserted in the form of a flat annular seal element into the bearing interior space which is delimited between the first bearing ring and the second bearing ring and which is located in front of the rolling body raceway. Said sensor element may be designed so as to interact with a transducer ring which is likewise inserted so as to be embedded under the end surfaces of the rolling bearing devices.

### BRIEF DESCRIPTION OF THE DRAWINGS

Further details and features of the invention emerge from the following description in connection with the drawing, in which:

FIG. 1 shows a perspective exploded illustration for visualizing the design of a rolling bearing device according to the invention;

FIG. 2 shows a perspective illustration of a rolling bearing device according to the invention in the fully assembled state;

FIG. 3 shows an axial section for visualizing the design of the rolling bearing device according to the invention in an axial section plane which perpendicularly intersects the rolling body race chamber;

FIG. 4 shows a sectional diagram for visualizing one particularly preferred design of a sealing disk element provided for the realization of the sensor system according to the invention;

FIG. 5 shows two perspective illustrations for visualizing a further variant of a rolling bearing device according to the invention having a sensor element attached to a modified standard bearing sealing disk;

FIG. 6 shows a further illustration for visualizing the design of a rolling bearing device according to the invention having a sensor element adhesively bonded to a modified sealing disk device;

FIG. 7a shows a perspective exploded illustration for visualizing a further variant of a rolling bearing device according to the invention, having a transducer ring which is attached to the bearing inner ring in an embedded fashion;

FIG. 7b shows a perspective illustration of the rolling bearing device according to

FIG. 7a in a fully assembled state;

FIG. 8 shows a cross-sectional view of a further exemplary embodiment of a rolling bearing device according to the invention;

FIG. 9 shows a cross-sectional view of another further exemplary embodiment of a rolling bearing device according to the invention;

FIG. 10 shows a perspective view of an exemplary embodiment of a bearing cage according to the invention having a transducer structure; and

FIG. 11 shows a cross-sectional view of yet another further exemplary embodiment of a rolling bearing device according to the invention, into which the bearing cage illustrated in FIG. 10 is installed by way of example.

### DETAILED DESCRIPTION OF THE DRAWINGS

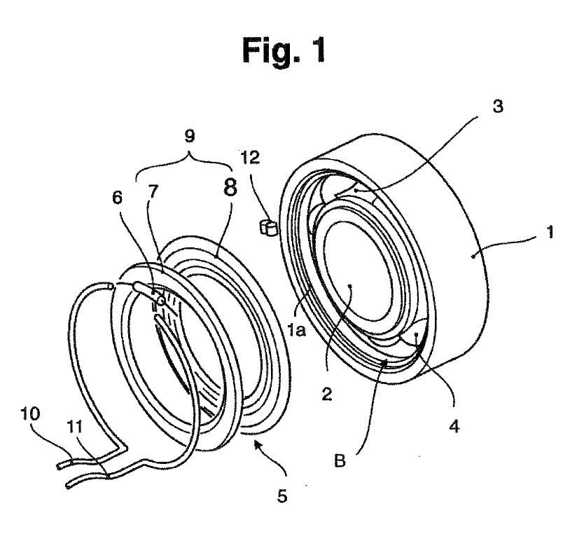

FIG. 1 shows, in the form of a perspective exploded illustration, a rolling bearing device according to the invention, according to a first preferred embodiment of the invention, which is designed as a deep-groove ball bearing. Said rolling bearing device comprises a first bearing ring 1, which functions here as a bearing outer ring, and a second bearing ring 2, which functions as a bearing inner ring.

A race chamber B is delimited between the first bearing ring 1 and the second bearing ring 2, in which race chamber B are held rolling bodies 3. Said rolling bodies 3 are guided by means of a cage device 4, such that a required circumferential spacing is maintained at all times between the individual rolling bodies 3 in the circumferential direction. The cage device 4 may be produced from a plastic material or else from a metal material.

The rolling bearing device according to the invention also comprises a sensor system 5 which itself serves to generate a sensor signal which relates to the relative rotation of the second bearing ring 2 (bearing inner ring) with respect to the first bearing ring 1 (bearing outer ring). Said sensor system 5 is designed such that said sensor signal is generated on the basis of an interaction effect between a signal tapping element 6 and a structure which rotates together with the cage device 4. In the exemplary embodiment illustrated here, the signal tapping element 6 is incorporated directly into a bearing cover ring which functions as a sealing plate. Said bearing cover ring comprises an annular core 7 and an elastomer structure 8 which is vulcanized onto said annular core 7. The bearing cover ring itself forms a flat annular disk, which can be inserted so as to be embedded over its entire area, into the annular chamber which can be seen here and which is situated in front of the race chamber B and which is formed between the first bearing ring 1 and the second bearing ring 2.

In the exemplary embodiment shown here, the bearing cover ring 9, which is formed by the annular core 7 and the elastomer structure 8, is fixed to the first bearing ring 1, that is to say to the bearing outer ring. Said fixing takes place by means of the sealing fixing groove 1a, which is formed, as is conventional, in the first bearing ring 1 for bearing sealing rings.

In the exemplary embodiment shown here, the sensor element 6 according to the invention is designed as a reed sensor which is incorporated (for example by injection molding) entirely into the annular disk core 7, which functions as a reinforcement.

The structure which is formed in this way is encased in an elastomer material casing so as to form the elastomer structure 8.

Connecting cables 10, 11 are incorporated into the sensor system according to the invention, via which connecting cables 10, 11 the detection events generated by means of the sensor element 6 can be tapped.

On the basis of the concept according to the invention, it is possible, by modifying a standard bearing, that is to say, by exchanging a standard sealing lip for a sealing lip which is fitted with a sensor element 6 according to the invention, and, if appropriate, by attaching a transducer element 12 to the rolling bearing cage 4 to create a rolling bearing device, which itself enables a detection of the rotation of the bearing inner ring with respect to the bearing outer ring on the basis of the measurement of the rotation of the rolling bearing cage 4. On the basis of a transmission ratio which can be determined for the respective bearing from the dimensions of the bearing rings, it is possible to determine the rotational speed of the inner ring 2 with respect to the outer ring 1 from the rotational speed of the cage 4.

It is possible to fit a transducer element to the cage device by modifying a standard cage. It is preferable for a plurality of transducer elements to be incorporated into the cage device in such a way that no imbalances are generated.

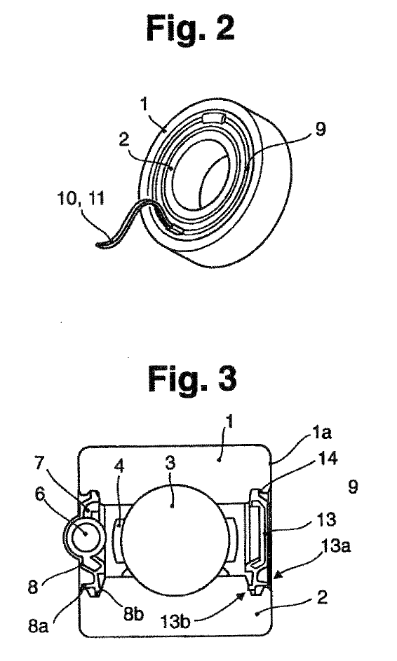

FIG. 2 illustrates, in the form of a perspective illustration, a rolling bearing device according to the invention in the fully assembled state. As can be seen from said illustration, the bearing seal 9, which is provided for sealing off the race chamber B, extends in the manner of a flat sealing disk between the inner ring 2 and the outer ring 1. The corresponding connection ends of the connecting cable 10, 11 are guided directly out of said sealing disk 9. Said connecting cable may be designed as a typical strand-type cable, or preferably as a flat-conductor-type cable.

FIG. 3 illustrates, in the form of an axial sectional illustration, the region of a rolling bearing device according to the invention at the level of the race chamber B. The right-hand side of the rolling bearing device in this illustration is sealed off by means of a standard sealing lip 13. Said standard sealing lip is clipped into a circumferential groove 14 which is formed in the region of the front face end 1a of the outer ring 1.

The seal device 13 forms a first sealing lip 13a and a second sealing lip 13b, which are seated on corresponding circumferential surfaces of the inner ring 2 and thereby seal the race chamber B of the rolling bearing device with respect to the environment. It is also possible for the sealing disk device 13 to be designed so as to be fixed to the second bearing ring (in this case the inner ring) and to bear by means of corresponding sealing lip sections against circumferential surfaces of the first bearing ring 1.

On a side facing away from the standard seal 13, the rolling bearing, which is illustrated here, is provided with a seal device with an incorporated sensor element 6. The sensor element 6 is designed and arranged such that it can generate a measurement signal, which correlates with the movement of the cage device 4 past said sensor element 6. Said measurement signal may, in particular, be generated by virtue of a transducer element (reference numeral 12, FIG. 1), incorporated as a permanent magnet or at least ferromagnetic structure, being incorporated into the cage device 4. It is also possible for the sensor element 6 to be designed so as to detect the approach of a rolling body 3 or of a structure, which bulges in the direction of the sensor element 6, of the cage device 4.

As can be seen from said illustration, the sensor device according to the invention comprises a support body 7 and an elastomer casing 8, which is integrally formed thereon, and which is composed of an elastomer material. Those sections of the sealing disk 9 which are provided for actualizing the sealing lips 8a, 8b form an integral constituent part of said elastomer casing 8.

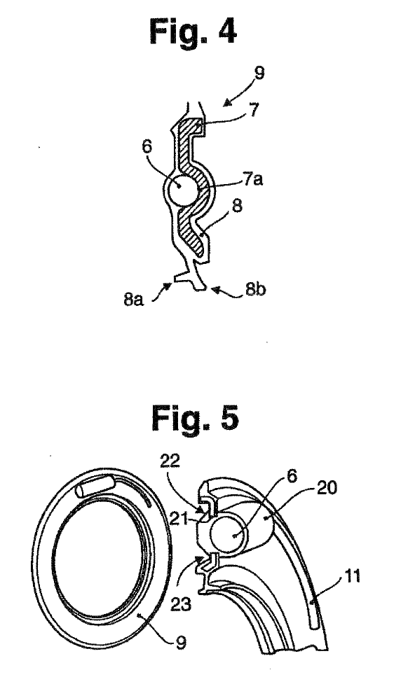

FIG. 4 illustrates a further variant of a seal element provided for forming a rolling bearing device according to the invention. Said seal element 9 comprises, similarly to the exemplary embodiment in FIGS. 1 to 3, a reinforcement core 7, which is produced from a relatively dimensionally rigid material, in particular plastic, and an elastomer casing 8, which is integrally formed on said reinforcement core 7 and which is composed of an elastomer material. The sealing lips 8a, 8b form integral constituent parts of said elastomer casing 8.

In the exemplary embodiment shown here, the sensor element 6 according to the invention, which sensor element 6 may also be embodied here particularly as a reed contact, is inserted into a depression 7a formed in the reinforcement 7. The sensor element 6 is incorporated into the seal device according to the invention in a fully sealed-off manner by virtue of the sensor element 6 according to the invention being covered, over its entire area, by the elastomer casing 8. It is possible for the sensor element 6 to be secured to the reinforcement 7 by means of said elastomer material casing 8. The connecting cables (see FIG. 1) provided for tapping the measurement results generated by the sensor device 6 according to the invention may preferably be guided out of the seal element 9 at a circumferential section of said sealing element 9 situated diametrically opposite the sensor element 6 with respect to the bearing axis.

To ensure high-strength adhesion of the elastomer casing 8 to the reinforcement body 7, it is possible for the latter to be pre-treated, in particular subjected to a corona irradiation, in such a way that the elastomer material provided for forming the elastomer casing 8 forms a cohesive connection with the material provided for forming the reinforcement body 7.

FIG. 5 illustrates a further variant of a sensor system according to the invention, by means of which sealed rolling bearings which are known per se can be reconfigured into sensor bearings according to the invention. In the exemplary embodiment shown here, the sensor element 6 according to the invention is provided with a sensor housing 20, with said sensor housing 20 being anchored in an aperture 21 which is formed in the rolling bearing seal 9. For this purpose, the sensor housing 20 is provided with engage-behind claws 22, 23 which, themselves, at a sealing ring outer side facing away from the sensor element 6, engage behind the wall surrounding the recess 21. It is possible for the sensor housing 20 to be designed such that the sensor housing 20 rests on the circumferential surface region surrounding the recess 21 with a sufficient sealing action. The connecting cable 11′ which is provided for tapping the measurement results generated by the sensor element 6 is connected to the sealing disk according to the invention by means of a sufficiently long fastening section, which acts as a strain relief facility, and is guided out of the sealing ring at a position spaced apart from the measuring point in the circumferential direction. In the exemplary embodiment of FIG. 5, the reed contact is seated in a housing 20 and is thereby clipped to a rolling bearing seal, which has a corresponding cutout for holding the sensor housing. The system composed of seal and sensor is inserted into the sealing groove on the outer ring of the rolling bearing, as described with regard to the exemplary embodiment according to FIG. 1.

FIG. 6 illustrates a further variant of a bearing sealing ring embodied according to the invention as a sensor sealing ring. The statements made regarding the exemplary embodiment according to FIG. 5 apply substantially analogously to this exemplary embodiment. In this exemplary embodiment, in contrast to the exemplary embodiment according to FIG. 5, the sensor housing 20 is not clipped to the sealing disk ring 9, but rather adhesively bonded thereto. It is also possible for the sensor element according to the invention to be fixed to the sealing ring 9 according to the invention either by being clipped on or by means of the additional provision of an adhesive.

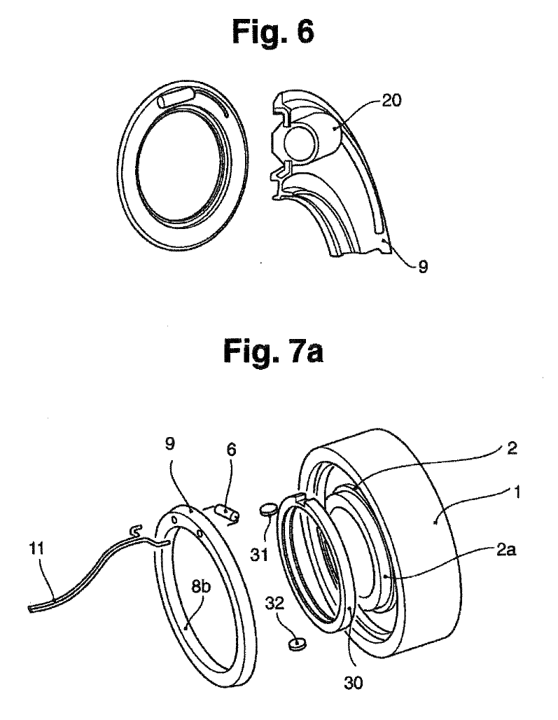

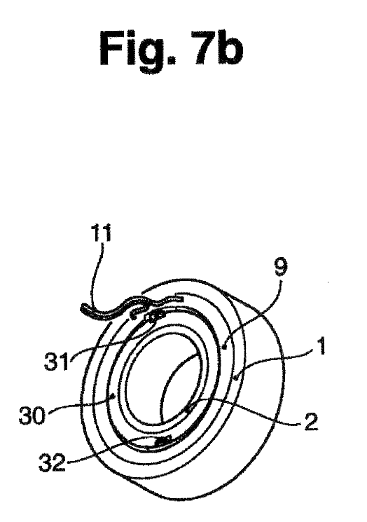

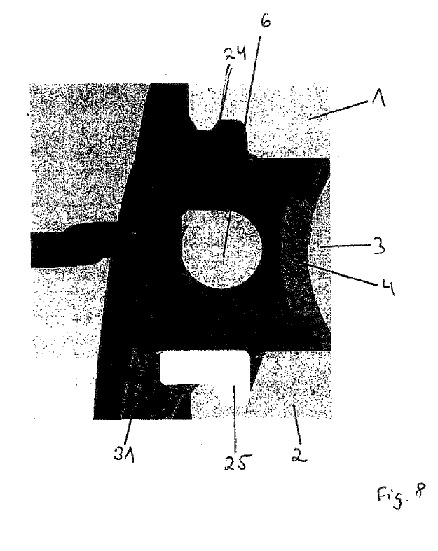

FIG. 7a illustrates a further exemplary embodiment of a rolling bearing device according to the invention. In said exemplary embodiment, in contrast to the exemplary embodiments described above, no direct measurement of the relative movement of the bearing cage with respect to the seal device is carried out, but rather the relative rotation of the bearing inner ring 2 with respect to the bearing outer ring 1 is detected. For this purpose, an annular shoulder 2a is formed on the bearing inner ring 2, onto which annular shoulder 2a can be placed a ring element 30 which functions as a transducer element support. Two permanent magnet bodies 31, 32, which function as transducer elements, are incorporated into said ring element 30. The movement of said transducer elements 31, 32 past the sensor element 6, which is designed here as a reed contact, may be detected by means of a corresponding voltage signal which is applied to the connecting cable 11′. The sensor element 6 is incorporated into a sealing ring structure 9, which can be incorporated in a fully embedded fashion into the rolling bearing device. Said sealing ring structure 9 is designed so as to be seated on the transducer ring 30, and border the latter, coaxially. The sealing lip 8b, which is provided by the sealing ring structure 9, is designed so as to again be seated on an outer circumferential surface of the bearing inner ring 2.

It is possible for a plurality of sensor elements 6 to be arranged on the sealing ring 9. It is also possible for a plurality of transducer elements 31, 32 to be arranged on the transducer element support ring 30. It is possible for the circumferential positions of the transducer elements and of the sensor elements to be coordinated in such a way that the relative rotation of the two bearing rings 1, 2 with respect to one another can be measured with an increased resolution.

It is possible for a miniature circuit, realized for example as an ASIC, to be provided in particular in the direct vicinity of the sensor element 6, which miniature circuit serves to carry out signal processing of the measurement events generated by the transducer elements 31, 32 and the sensor elements which interact therewith. It is in particular also possible for protective circuits for preventing damage to the sensor elements, and also circuits for providing the measurement signals in a suitable data format, to be realized in the region of said ASIC. A further option for the actualization (FIG. 8) of a low-cost sensor bearing based on reed contacts is for the permanent magnets to be fastened not to the cage 4, but rather to a second bearing ring, which is formed as an inner ring 2 of the rolling bearing. The reed contact serves as a sensor element 6 of a sensor system and is seated on a support ring 24 which is fastened to a first bearing ring, which first bearing ring is designed as an outer ring 1 of the rolling bearing and is produced for example from plastic, in particular from a non-magnetic material, such that the support ring 24 does not influence the reed contact 6, which responds to a magnetic field. A further ring 25, which is fastened to the inner ring 2, supports any defined amount of permanent magnets as transducer elements 31. The cross-sectional view in FIG. 8 shows one of a plurality of permanent magnets 31, one of the two poles (denoted by the different color) of which permanent magnet faces toward the reed sensor 6. Here, it is self-evident that the reed contact may alternatively be arranged directly on the outer ring 1 by virtue of said reed contact being fastened directly to the outer ring 1. It is also self-evident that the reed contact 6 need not be fastened by means of the support ring 24 to the outer ring 1; provision may instead be made for the reed contact 6 to be arranged on an inwardly pointing molded portion of the outer ring 1. Regardless of the physical type of fastening of the reed contact 6 to the outer ring 1, be it either directly or with the interposition of the support ring 24 or a similar element, the permanent magnets, or generally, the transducer elements 31, the magnetic signal of which the reed contact 6 is responding to, may also be arranged directly on the inner ring 2 or on a projection of a section of the inner ring 2. Alternatively, provision may also be made for the signal transducer or the transducer element 31, specifically the at least one permanent magnet, to be arranged on the bearing cage 4. It is likewise self-evident that the reed contact 6 may be arranged on the inner ring 2, be it via a support ring, which is fastened to the inner ring 2, or by being directly fastened to the inner ring or to a projection on a section of the inner ring 2. If the reed contact 6 is fastened to the inner ring 2, the at least one signal transducer 6, specifically the at least one permanent magnet, may be arranged on the bearing cage or on the outer ring, specifically, in the case of arrangement on the outer ring, either directly on the outer ring or on a further ring, which in turn is fastened to the outer ring.

No seal is provided in the exemplary embodiment illustrated in FIG. 8. It is self-evident that a seal may additionally be provided which engages over the support ring 24 and the further ring 25. Alternatively, a sealing lip may be provided on the support ring 24, which sealing lip covers the gap between the support ring 24 and the further ring 25.

It is likewise self-evident that the support ring 24, which is illustrated in cross section in FIG. 8, in particular also in the embodiment of the support ring 24 which is shown, may also be fastened to a seal which is not illustrated in FIG. 8, for which purpose in particular no structural modifications, or only minor structural modifications, need be made to the embodiment of the support ring 24 which is shown.

FIG. 7b illustrates the rolling bearing, which is broken down into its individual parts in FIG. 7a in the fully assembled state. As can be seen from this view, the rolling bearing device according to the invention is designed such that neither the sealing ring structure 9, which supports the sensor element 6 (compare FIG. 7a) nor the transducer ring structure 30, which supports the transducer rings 31, 32, protrude beyond an end plane, which is defined by the end surfaces of the first bearing ring 1 and of the second bearing ring 2, of the rolling bearing. During the installation of said rolling bearing device according to the invention, it is merely necessary for sufficient cable guiding space for leading out the connecting cable 11 to be provided in the region of the connecting cable 11. It is possible for a recess to be formed on the outer ring 1, which recess is dimensioned so as to be deep enough to hold the connecting cable 11, such that the connecting cable 11 can be guided out radially in the region of the end surface of the bearing outer ring 1 without projecting beyond the end plane defined by the end surface of the bearing ring 1.

In the exemplary embodiments described above, the signal transducer was formed by a permanent magnet, that is to say by a substantially punctiform magnetic field. It shall be understood, however, that a substantially areal magnetic field may also be provided as a signal transducer.

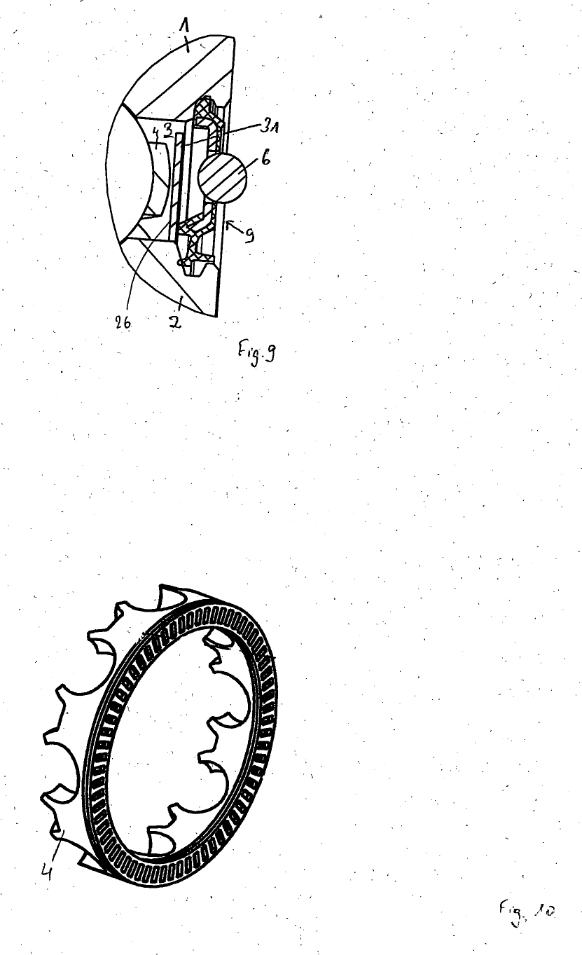

FIG. 9 shows a rolling bearing having an inner ring which is formed as a first bearing ring 2, an outer ring which is formed as a second bearing ring 1, and a seal device 9 which is connected to the outer ring 1 and also a sensor system. The sensor system comprises a reed contact 6, which is structurally integrated into the seal device 9, as a sensor element, and an encoder ring 26, which is designed as a signal transducer. The encoder ring 26 is formed in the shape of a circular ring and comprises a sequence of two or more areal regions along its circumference, with the magnetization of two adjacent areal regions each being different; this includes the possibility of one of the regions of the encoder ring having no magnetization. The encoder ring 26 is fastened to the inner ring 2 and is arranged with a spacing to the outer ring 1, to the seal device 9 and to the bearing cage 4. The encoder ring 26 is arranged substantially centrally in the race chamber B between the two bearing rings 1, 2, such that the magnetized regions of the encoder ring 26 are spaced apart from the reed contact 6 by only a short distance. It is self-evident that the encoder ring 26 may also be arranged on the outer ring 1, if the reed contact 6, or generally the sensor element of the sensor system, is arranged on the inner ring or on the seal device which is connected to the inner ring. It is also self-evident that the encoder ring 26 may be arranged on the bearing ring 1 or 2 either directly or indirectly, with the interposition of a support ring.

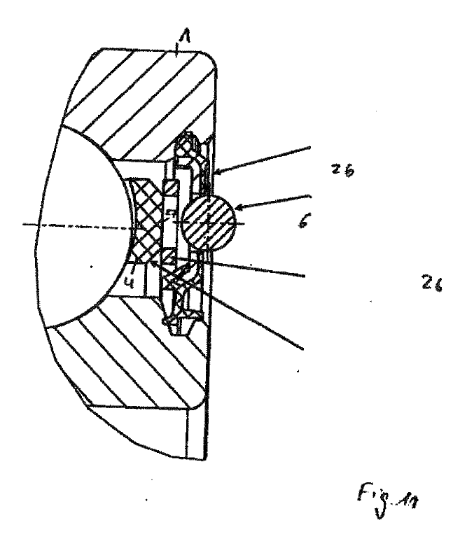

FIG. 10 shows one half of a bearing cage 4, which is formed as a plastic snap-action cage. An encoder disk 26 is fastened to an end surface of the body of the bearing cage 4. The encoder disk 26 is designed as a circular ring which has an encircling sequence of recesses, in particular punched-out portions of approximately rectangular outline, with the punched-out portions being formed in the shape of circular sectors. The encoder disk 26 is fastened to the end surface of the body of the bearing cage 4 by adhesive bonding. It is self-evident, that the body of the encoder disk 26 may comprise, at its outer edge, an encircling bead, which engages into a groove which is likewise provided in an encircling fashion on the body of the bearing cage 4, in order to thereby fasten the encoder disk 26 to the body of the bearing cage 4.

It is self-evident that the encoder disk 26 may also be inserted into the body of the bearing cage 4 by being plugged in, clipped in or encapsulated by injection molding by means of the shaping of plastic during the production of the body of the bearing cage 4, or fastened to the bearing cage 4 in some other way. If the bearing cage 4 is formed from plastic, the end surface or the rear of the bearing cage 3 may be formed from a magnetizable plastic, and thereby form an encoder disk.

FIG. 11 shows a bearing cage 4, which is likewise designed as a plastic snap-action cage and to the end surface 27 of which the encoder disk 26 is fastened. The encoder disk 26 may be fastened by being pressed onto the end surface 27 of the bearing cage 4, with the encoder disk 26 being pushed, in sections, laterally over an edge of the end surface 27. The sensor element is designed as a reed sensor 6 which is structurally integrated into a seal device 9. The seal device 9 is connected to the first bearing ring 1, in this case the outer ring, such that the encoder disk 26 is moveable relative to the reed sensor 6, which is designed as a sensor element of the sensor device, during operation of the rolling bearing.

The invention is not restricted to the exemplary embodiments described above. Instead of detecting the movement of corresponding transducer structures past the respective sensor element, it is also possible for the sensor element to be designed such that it can detect the alignment of a magnetic field generated by the transducer elements 31 and 32 in the region of the rolling bearing device, with changes in the alignment of said magnetic field, such as occur even in the event of small relative rotations of the bearing rings 1, 2 with respect to one another, can already be detected by means of the sensor element without it being necessary for the transducer structures to be situated in the direct vicinity of the sensor element 6.

The sensor elements 6 may also be designed structurally so as to form extremely flat assemblies, such that no considerable axial thickening of the sealing disk element occurs even in the region of the points at which the sensor elements are mounted on the sealing disk element.

Instead of the connecting cables specified here for enabling the measurement events generated by means of the sensor elements according to the invention to be tapped, it is also possible for a signal or information transfer to be carried out in some other way. The sealing disk device according to the invention may also have incorporated into it an electronic circuit which serves as a counter for counting bearing rotations or as a data memory for some other form of recording, in particular the recording of measurement variables which are relevant with regard to wear. The information recorded by means of said data carrier device may be read out after the rolling bearing according to the invention is disassembled or by means of some other suitable reading device, in particular also by visual means.

Rolling bearing devices which are designed according to the invention, in particular sealed deep-groove ball bearings with an integrated sensor, support rotating shafts and additionally detect relative movements of the two bearing rings. In particular, the rotational speed and direction of rotation are measured. From these it is possible to derive the rotational acceleration and number of rotations. Said information can be processed by control and regulating means in order to make it possible to electronically monitor and automatically operate systems and appliances. Typical applications for rolling bearings according to the invention with an integrated sensor are electric machines, in particular frequency-controlled three-phase induction motors, gearings, for example in machine tools, geared motors in appliances in conveyor technology, for example lifts, escalators, conveyor belts, forklift drives, textile machines and packaging machines.

On the basis of the concept according to the invention, it is possible to measure the rotations of the bearing components in a cost-effective manner with a small installation space requirement. As a result of the cost-effective sensor solution made possible according to the invention, which sensor solution simultaneously requires no additional installation space in relation to the standard installation space of the rolling bearing and which is easy to fit (that is to say even retroactively), it is possible to tap into new applications, in particular in the field of consumer goods. A reed contact is preferably used for rotational speed measurement. The reed contact is composed, for example, of a glass piston which contains a vacuum or which is filled with inert gas and into which are integrally cast two ferromagnetic contact tongues. The ends of the contact tongues project out of the piston and serve as terminals. The contact is connected by means of the two (solder) terminals to a switching circuit and, there, performs the function of a switch. The approach of a magnet causes the two contact tongues to be brought together, such that the circuit is closed and a voltage impulse can be detected.

For the possible solutions according to FIGS. 1 to 6, the magnets which are used to actuate the contacts are positioned on the bearing cage. This has the advantage that the service life of the sensor can be maximized since the actual rotational speed of the bearing is a determinable factor higher than the cage rotational speed. The measurement accuracy of the sensor bearing can be regulated by means of the number of magnets used. Furthermore, in the exemplary embodiments according to FIGS. 1 to 6, the reed contacts are fastened in or to a bearing seal, thereby ensuring simple and fast assembly and disassembly. The reed contact and the two connecting cables are preferably completely integrated into the reinforcement of the bearing seal (for example by injection molding). The reinforcement is subsequently encapsulated with an elastomer material.

In the exemplary embodiment according to FIG. 4, the reed contact and the connecting cables are not completely integrated into the reinforcement, but rather are merely laid in a groove provided for the purpose and are subsequently encased with the elastomer casing. The reinforcement therefore need not be molded from plastic but rather may also be designed, for example, as a sheet-metal molded part.

In the exemplary embodiments described above, the transducer element or the signal transducer, in particular the at least one permanent magnet or encoder disk 26, was structurally separated from the at least one rolling body 3 of the rolling bearing unit. It shall be understood, however, that the at least one rolling body 3 itself may be designed as a signal transducer or transducer element by virtue of the rolling body 3 having a magnetization which is detected by the reed contact or, more generally, the sensor element 6. The magnetization of the rolling body 3 may be provided by virtue of a permanent magnet being structurally integrated on or in the rolling body 3. Alternatively or in addition, the at least one rolling body 3 may be provided with a magnetization, since in many cases, rolling bodies are formed from a magnetizable material or already have magnetic properties.

In the above-described exemplary embodiments, the transducer element or the signal transducer was formed by a permanent magnet, that is to say by an element which was added to the associated bearing component, inner or outer ring or bearing cage. It shall be understood, however, that the body of the bearing component in question, that is to say the body of the inner ring or outer ring or of the bearing cage, may itself be provided with a magnetization in sections, such that it is no longer necessary for an additional element to be attached as a signal transducer to the respective body. In this way, it is possible to avoid imbalances which may occur for example when the bearing is running at high speeds, or to avoid the fastening of the transducer element or signal transducer element from loosening over time. The body of the inner or outer ring or of the bearing cage may for example be provided with a magnetization in sections by virtue of a short, intense current impulse being passed through the section, such that the current impulse generates a magnetic field which magnetizes the magnetizable material of the body in said section. Here, it is self-evident that the permanent magnetization of the section of the body of the respective bearing component may also be produced in some other way. For example, for a bearing cage which is produced from plastic, it is possible during the production of said bearing cage for magnetic material to be embedded into the plastic in sections. Alternatively, in the case of a bearing cage or bearing ring produced from plastic, it is possible for magnetic material to be added in sections to a sintered powder, and for the bearing cage or bearing ring to be produced by compressing the sintered powder. The rolling body may also be provided with a magnetization in this way if said rolling body is designed as a signal transducer or transducer element.

In the exemplary embodiments described above, each sensor system comprised in each case only reed contacts. It is self-evident that the sensor system may also comprise, in addition to the at least one reed contact, some other sensor element which can detect a magnetic field, for example one or more Hall sensors or Förster sensors.

Since the reed contact provides a signal a closed or open current circuit as an output signal, that is to say only two states, it may be advantageous for a further sensor such as a Hall sensor to measure the magnitude of the magnetic field, in particular at the point at which the reed contact has detected the magnetic field, in the event that the reed contact generates a closed current circuit. It is therefore particularly possible for two or more signal transducers to be designed in such a way that each signal transducer has a different magnetic field, with each individual one of the magnetic fields being dimensioned such that it can be detected by the reed contact. In this way, it is possible to obtain an improved spatial resolution in the rolling bearing.

1. A rolling bearing device, comprising:
a first bearing ring, which is an outer ring;
a second bearing ring, which is an inner ring;
rolling bodies which are held in a race chamber delimited between the first bearing ring and the second bearing ring;
a cage for separating the rolling bodies; and
a sensor system for generating a sensor signal which relates to the relative rotation of the inner ring with respect to the outer ring,
wherein the sensor system is designed such that the sensor signal is generated on a basis of an interaction effect between a signal tapping element and a structure which rotates together with the cage.

2. The rolling bearing device of claim 1, wherein the signal tapping element is incorporated into a bearing cover ring.

3. The rolling bearing device of claim 2, wherein the bearing cover ring is fixed to the outer ring.

4. The rolling bearing device of claim 2, wherein the bearing cover ring is fixed to the bearing inner ring.

5. The rolling bearing device of claim 2, wherein the bearing cover ring is a bearing seal.

6. The rolling bearing device of claim 5, wherein the bearing cover ring is designed as a flat bearing sealing plate with integral sealing lips.

7. The rolling bearing device of claim 2, wherein the sensor element is incorporated into the bearing cover ring in such a way as not to project in an axial direction beyond an end surface region of the bearing cover ring.

8. The rolling bearing device of claim 1, wherein the sensor element is designed such that a structure which rotates with the cage is detected by electromagnetic interaction effects and/or electric field interaction effects.

9. The rolling bearing device of claim 8, wherein the structure which rotates with the cage forms an integral constituent part of the cage.

10. The rolling bearing device of claim 8, wherein the structure which rotates with the cage is formed by an element which is inserted into the cage.

11. The rolling bearing device of claim 10, wherein the element which is inserted into the cage is produced from a ferromagnetic material.

12. The rolling bearing device of claim 11, wherein the element which is inserted into the cage is a permanent magnet element.

13. The rolling bearing device of claim 8, wherein the structure which rotates with the cage is designed as an encoder disk.

14. The rolling bearing device of claim 13, wherein the encoder disk is fastened to an end surface of a body of the cage.

15. The rolling bearing device of claim 14, wherein the body of the cage is composed of plastic.

16. The rolling bearing device of claim 13, wherein the cage is a snap-action cage.

17. The rolling bearing device of at least one of claims 1, wherein the sensor element comprises a reed contact.

18. The rolling bearing device of claim 1, wherein the sensor element comprises an induction coil device.

19. The rolling bearing device of claim 1, wherein the sensor element comprises a Hall effect sensor structure.

20. The rolling bearing device claim 1, wherein an ASIC circuit is incorporated into the rolling bearing in order to realize signal pre-processing of the measured detection events.

21. The rolling bearing device of claim 20, wherein the ASIC circuit comprises an operational amplifier.

22. The rolling bearing device of claim 20, wherein the ASIC circuit comprises a protective circuit.

23. The rolling bearing device of claim 20, wherein the ASIC circuit provides an output signal in a BUS format.

24. The rolling bearing device of claim 1, wherein the sensor system comprises a plurality of sensor elements.

25. The rolling bearing device of claim 24, wherein the circumferential angular spacing of the sensor elements is coordinated with the circumferential angular spacing of the detected structures in such a way that relative movement of the detected structures with respect to the sensor elements is measured with an increased resolution.

26. A bearing cage for a rolling bearing device, comprising: an encoder disk which is fastened to a body of the cage.

27. The bearing cage of claim 26, wherein the encoder disk is fastened to an end surface of the body.

28. The bearing cage of claim 26, wherein the body of the cage is composed of a non-magnetic material, in particular of plastic.

29. The bearing cage of claim 26, wherein the body of the cage is a snap-action cage with two halves, and in that the encoder disk is fastened to one of the halves of the snap-action cage.

30. A rolling bearing device, comprising:
a first bearing ring, which is an outer ring;
a second bearing ring which is an inner ring;
rolling bodies which are held in a race chamber delimited between the first bearing rings ring and the second bearing ring;
a cage for separating the rolling bodies;
a seal device for sealing off a race chamber with respect to a bearing outer region; and
a sensor system for generating a sensor signal which relates to the relative rotation of the inner ring with respect to the outer ring,
wherein the seal device a flat annular disk which is incorporated into the rolling bearing device in such a way as not to project beyond a by an end surface of the outer bearing ring, and in that the sensor device has a sensor element which is incorporated into the seal device.

31. The rolling bearing device of claim 30, wherein the sensor device has a ring element and a transducer element which is incorporated into the ring element.

32. The rolling bearing device of claim 31, wherein the ring element is placed onto an annular step which is formed on the inner ring.

33. A rolling bearing device, comprising:
an inner ring;
an outer ring; and
a sensor system for generating a sensor signal which relates to relative rotation of the inner ring and the outer ring, with the sensor system having at least one permanent magnet as a signal transducer and a reed contact as a sensor element of the sensor system,
wherein the at least one permanent magnet is fastened to the inner ring, and the reed contact is fastened to a support ring which is fastened to the outer ring.

34. The rolling bearing device of claim 33, wherein a further ring is fastened to the inner ring, and the at least one permanent magnet is fastened to the further ring.

35. A rolling bearing device, comprising:
a first bearing ring, which is an outer ring;
a second bearing ring, which is an inner ring;
at least one rolling body which is held in a race chamber delimited between said two bearing rings; and
a sensor system for generating a sensor signal which relates to the relative rotation of the inner ring with respect to the outer ring, with the sensor system comprising a sensor element and a signal transducer,
wherein the sensor element comprises at least one reed contact, and the at least one reed contact detects a magnetic signal of the signal transducer as a sensor signal.

36. The rolling bearing device of claim 35, wherein the rolling bearing device further comprises a sealing device, and the at least one reed contact is arranged on the sealing device.

37. The rolling bearing device of claim 35, wherein the at least one reed contact is fastened to the first or second bearing ring.

38. The rolling bearing device of claim 37, wherein a support ring is fastened to the first bearing ring, and the at least one reed contact is fastened to the support ring.

39. The rolling bearing device of claim 35, wherein the signal transducer is arranged on the second bearing ring.

40. The rolling bearing apparatus of claim 39, wherein the second bearing ring comprises a further ring, and in that the signal transducer is fastened to the further ring.

41. The rolling bearing apparatus of claims claim 34, wherein the rolling bearing further comprises a cage, and the signal transducer is arranged on the cage.

42. The rolling bearing apparatus of claim 35, wherein the signal transducer is formed by at least one permanent magnet.

43. The rolling bearing apparatus of claim 41, wherein the signal transducer is formed by at least one magnetized section of the inner ring, of the outer ring or of the cage.

44. The rolling bearing apparatus of claim 35, wherein the at least one rolling body is a signal transducer, with the at least one rolling body having a magnetization which is detected by a reed contact.

45. The rolling bearing apparatus of claim 35, wherein the signal transducer is formed by an encoder disk.

46. The use of a reed contact as a sensor element in a sensor system of a rolling bearing, with the sensor system measuring a relative movement of a first bearing ring and a second bearing ring of the rolling bearing.
